(19) United States
(12) Patent Application Publication
(10) Pub. No.: US 2012/0113334 A1
(43) Pub. Date: May 10, 2012

(54) LCD PROJECTOR

(75) Inventors: Kazuya Minami, Hirakata-shi (JP); Yuji Matsuyama, Daito-shi (JP)

(73) Assignee: SANYO ELECTRIC CO., LTD., Osaka (JP)

(21) Appl. No.: 13/291,224

(22) Filed: Nov. 8, 2011

(30) Foreign Application Priority Data
Nov. 9, 2010 (JP) 2010-251061

(51) Int. Cl. G02F 1/1335

(52) U.S. Cl. 349/5

(57) ABSTRACT

An LCD projector including liquid crystal light valves, a duct, and nozzles. Each liquid crystal light valve includes optical components. Cooling air flows through the duct to cool the optical components of each liquid crystal light valve. The nozzles are arranged in correspondence with the liquid crystal light valves and blow the cooling air from the duct toward the optical components of the corresponding liquid crystal light valves. At least one nozzle includes an inlet, which is in communication with the duct, and an outlet, from which the cooling air from the inlet is blown out. The outlet has a width in a direction orthogonal to an optical axis of light that is set so that a blowing range of the cooling air is selected for each optical component in the corresponding liquid crystal light valve.

### CROSS-REFERENCE TO RELATED APPLICATIONS

This application is based upon and claims the benefit of priority from prior Japanese Patent Application No. 2010-251061, filed on Nov. 9, 2010, the entire contents of which are incorporated herein by reference.

### BACKGROUND ART

The present invention relates to an LCD projector, and more particularly, to a cooling system that cools a liquid crystal light valve with cooling air.

An LCD projector that enlarges and projects an image, which is formed by liquid crystal light valves, onto a screen via a projection lens is known in the prior art. One example of such a liquid crystal projector is a so-called three-chip LCD projector that displays a color image using transmissive liquid crystal light valves for red light, green light, and blue light. For such a three-chip LCD projector, Japanese Laid-Open Patent Publication Nos. 2010-61004, 8-234155, and 2007-298890 describes examples of cooling systems that cool optical components of liquid crystal light valves.

Each of these cooling systems includes a cooling fan, which produces cooling air, a duct, through which the cooling air flows from the cooling fan, and nozzles (also referred to as outlets), which blows out the cooling air from the duct and toward the optical components. A nozzle is provided for each of the liquid crystal light valves for red light, green light, and blue light. Each nozzle includes an entrance side nozzle, which sends cooling air to the optical components located at the entrance side of an LCD panel, and an exit side nozzle, which sends cooling air to the optical components located at the exit side of an LCD panel.

As one specific example of such a prior art cooling system, the structure described in Japanese Laid-Open Patent Publication No. 2010-61004 will now be described with reference to FIGS. 1 to 3.

As shown in FIG. 1, a duct 100 includes a connection port 101, which connects a first cooling fan that sends cooling air to a liquid crystal light valve for green light, and a connection port 102, which connects a second cooling fan that sends cooling air to liquid crystal light valves for blue light and red light. Further, a plurality of nozzles 110 are arranged on an upper surface of the duct 100. The nozzles 110 include a nozzle 110G for green light that sends cooling air to the green liquid crystal light valve, a nozzle 110B for blue light that sends cooling air to the blue liquid crystal light valve, and a nozzle 110R for red light that sends cooling air to the red liquid crystal light valve. The nozzles 110G, 110B, and 110R include entrance side nozzles 111G, 111B, 111R and exit side nozzles 112G, 112B, and 112R, respectively.

Referring to FIG. 2, the liquid crystal light valves are arranged next to a cross dichroic prism 121, which combines the light of each color. In the order of arrangement from the entrance side toward the cross dichroic prism 121, each liquid crystal light valve includes an entrance pre-polarizer 122 (inorganic polarizer), an entrance polarizer 123, an optical compensator 124, an LCD panel 125 including liquid crystal cells and the like, an exit pre-polarizer 126, and an exit polarizer 127. The entrance side nozzle 111 of the corresponding nozzle 110 is formed to send the cooling air from the duct 100 to the entrance side optical components, which are arranged from the entrance pre-polarizer 122 to the LCD panel 125. Further, the exit side nozzle 112 of the corresponding nozzle 110 is formed to send the cooling air from the duct 100 to the exit side optical components, which are arranged from the LCD panel 125 to the exit polarizer 127. In this specification, when the nozzles 110, the entrance side nozzles 111, and the exit side nozzles 112 are described without the characters R, G, B, r, g, and b, this indicates that these components can be applied to any color.

Further, as shown in FIGS. 2, 3A, and 3B, the entrance side nozzle 111 and exit side nozzle 112 of each nozzle 110 are pyramidal and formed so that an opening dimension in an optical axis direction X and an opening dimension in a widthwise direction Y, which is orthogonal to the optical axis, increase from outlets 111a and 112a to inlets 111b and 112b. Further, a deflector 113 is arranged between the inlet 111b of the entrance side nozzle 111 and the inlet 112b of the exit side nozzle 112 and projects into the duct 100. The deflector 113 has a width that is generally the same as the nozzle width. The cooling air circulating through the duct 100 strikes the deflector 113. As a result, the deflector 113 increases the amount of air that flows to the entrance side nozzle 111. Accordingly, the projecting dimension of the deflector 113 adjusts the amount of air flowing to the entrance side nozzle 111. Further, the adjustment of the amount and direction of the air flowing to the entrance side nozzle 111 and the exit side nozzle 112 is determined by the inlet area, the outlet area, and the nozzle shape of each of nozzles 111 and 112.

As illustrated in FIGS. 3A and 3B, in the nozzle 110 of the prior art cooling system, the entrance side nozzle 111 and the exit side nozzle 112 are both pyramidal and the dimensions in the optical axis direction X and the dimensions in the widthwise direction Y, which is orthogonal to the optical axis, become smaller as the outlets 111a and 112a become closer. Thus, as shown in FIGS. 1 and 2, a large gap 114 is formed between the outlet 111a of the entrance side nozzle 111 and the outlet 112a of the exit side nozzle 112. As a result, cooling air is not sent to locations corresponding to the gap 114. This lowers the cooling effect of the optical components. Further, the deflector 113 is formed between the inlet 111b of the entrance side nozzle 111 and the inlet 112b of the exit side nozzle 112 to adjust the amount of air. However, the thickness of the deflector 113 occupies and reduces space at the inlet of the nozzle 110. Thus, the deflector 113 produces a circulation resistance at the inlet. Further, a burble flow is produced near the distal end of the deflector 113, and an eddy flow is produced from a distal portion to a rear portion of the deflector 113. This also increases the circulation resistance in the duct. In this manner, in the cooling system of the prior art, cooling air cannot be efficiently produced. In addition, a large noise is produced.

The amount of cooling air that cools the optical components of the liquid crystal light valves should be determined in accordance with the heat resistance of each optical component. Thus, the amount of cooling air should not be determined by separating optical components into entrance side optical components and exit side optical components using the LCD panel 125 as a boundary.

### SUMMARY OF THE INVENTION

One aspect of the present invention is an LCD projector including a plurality of liquid crystal light valves that modulate light, a duct, and a plurality of nozzles. Each of the liquid crystal light valves includes a plurality of optical components. Cooling air flows through the duct to cool the optical components of each of the liquid crystal light valves. The nozzles are respectively arranged in correspondence with the liquid crystal light valves. Each of the nozzles blows the cooling air from the duct toward the optical components of the corresponding liquid crystal light valve. At least one of the nozzles is formed by a single current passage that includes an inlet, which is in communication with the duct, and an outlet, which blows out the cooling air from the inlet. The outlet has a width in a direction orthogonal to an optical axis of light that enters the corresponding liquid crystal light valve. The width is set so that a blowing range of the cooling air is selected for each of the optical components in the corresponding liquid crystal light valve.

A further aspect of the present invention is an LCD projector including a plurality of liquid crystal light valves that modulate light, a duct, and a plurality of nozzles. Each of the liquid crystal light valves includes a plurality of optical components. Cooling air flows through the duct to cool the optical components of each of the liquid crystal light valves. The nozzles are respectively arranged in correspondence with the liquid crystal light valves. Each of the nozzles blows the cooling air from the duct toward the optical components of the corresponding liquid crystal light valve. At least one of the nozzles includes a single outlet that blows out the cooling air. The outlet is formed to blow the cooling air at a first velocity toward at least one of the optical components of the corresponding liquid crystal light valve and blow the cooling air at a second velocity toward at least another one of the optical components of the corresponding liquid crystal light valve.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a duct of a cooling system that cools liquid crystal light valves in the prior art;

FIG. 2 is a cross-sectional view showing the cooling system of FIG. 1;

FIGS. 3A and 3B are diagrams showing the shape of a nozzle in the cooling system of FIG. 1;

FIG. 4 is a schematic diagram showing an LCD projector according to one embodiment of the present invention;

FIG. 5 is a schematic diagram showing liquid crystal light valves in the LCD projector of FIG. 4;

FIG. 6 is a perspective view showing a duct in a cooling system that cools the liquid crystal light valves in the LCD projector of FIG. 4;

FIG. 7A is a plan view showing the cooling system of FIG. 6;

FIG. 7B is a cross-sectional view showing the cooling system of FIG. 6;

FIG. 8 is a perspective view showing a nozzle used in the cooling system of FIG. 6;

FIG. 9 is a plan view showing the nozzle of FIG. 8; and

FIG. 10 is a cross-sectional view taken along line F10-F10 in FIG. 8.

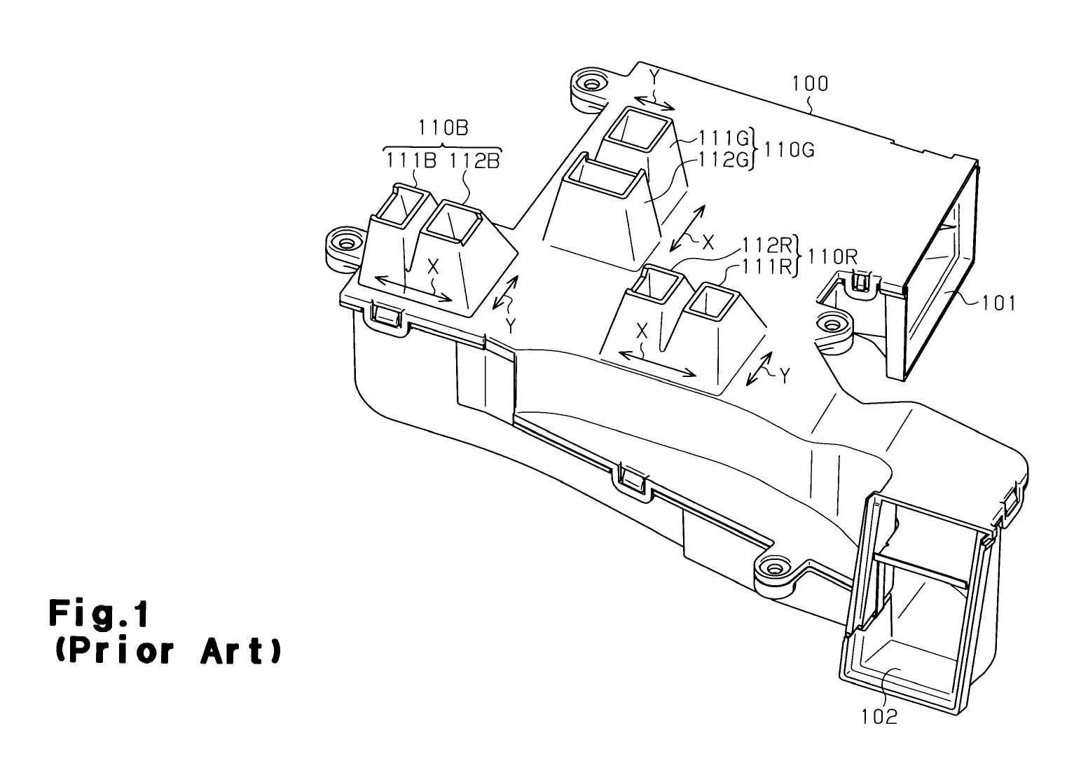

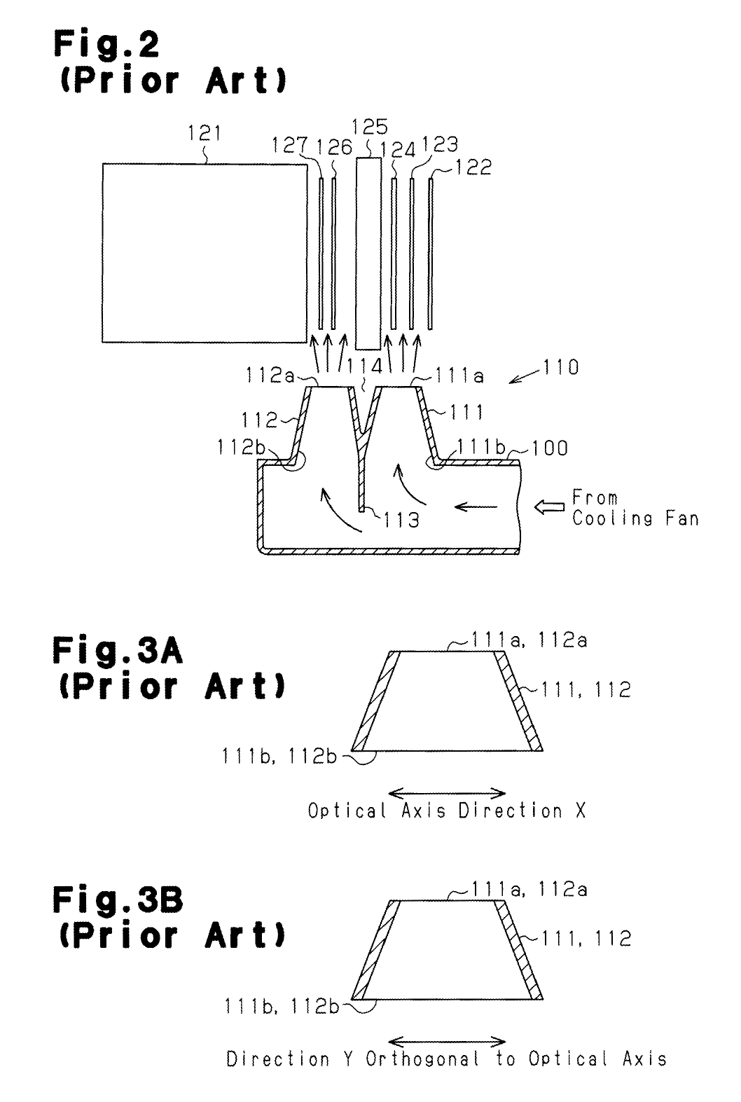

### DETAILED DESCRIPTION OF THE INVENTION

An LCD projector according to one embodiment of the present invention will now be described.

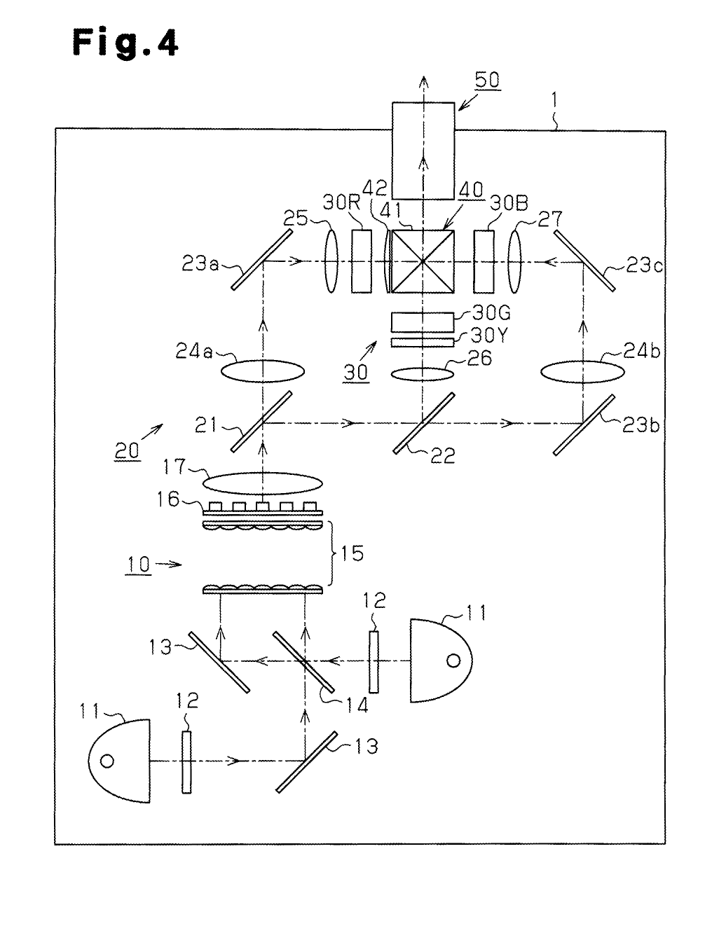

FIG. 4 shows the LCD projector, which is a three-chip LCD projector that uses LCD panels for red light, green light, and blue light. The LCD projector includes an outer case 1, which accommodates optical systems that will now be described.

The optical systems include an illumination optical system 10, a color separation optical system 20, a light modulator 30, a color combiner 40, and a projection lens 50. The illumination optical system 10 emits parallel white light. The color separation optical system 20 separates the light emitted from the illumination optical system 10 into plural colors of light. The light modulator 30 modulates the light of each color in accordance with image information. The color combiner 40 combines the modulated light of each color. The projection lens 50 projects the combined image light.

The illumination optical system 10 includes two light source lamps 11 that emit generally parallel light, two UV filters 12, two full reflection mirrors 13, a half mirror 14, an integrator lens 15, a polarization element 16 that converts incident light into predetermined polarized linear light components, and a condenser lens 17. The UV filters 12 eliminate UV components from the light emitted from the two light source lamps 11. The light that has passed through the UV filters 12 is combined by the two full reflection mirrors 13 and the half mirror 14. The combined light enters the integrator lens 15, which evenly distributes the illuminance of the light. The polarization element 16 converts the light emitted from the integrator lens 15 into one type of polarized light, which is sent via the condenser lens 17 to the color separation optical system 20.

The color separation optical system 20 includes dichroic mirrors 21 and 22, full reflection mirrors 23a, 23b, and 23c, relay lenses 24a and 24b, and condenser lenses 25, 26, and 27.

The light modulator 30 includes a red liquid crystal light valve 30R, a green liquid crystal light valve 30G, and a blue liquid crystal light valve 30B. The red liquid crystal light valve 30R modulates red light components. The green liquid crystal light valve 30G modulates green light components. The blue liquid crystal light valve 30B modulates blue light components. In this embodiment, a Ye modulation element 30Y, which modulates yellow light components, is arranged at the entrance side of the green liquid crystal light valve 30G.

The color separation optical system 20 and the light modulator 30 will now be described in further detail.

The dichroic mirror 21 transmits the red light components in the white light emitted from the illumination optical system 10 and reflects the green, yellow, and blue light components in the white light. The red light components enter the red liquid crystal light valve 30R, which functions as a light modulating means, via the relay lens 24a, the full reflection mirror 23a, and the condenser lens 25. The red light components entering the red liquid crystal light valve 30R is modulated and then sent to a cross dichroic prism 41, which forms the color combiner 40, via an aberration correction lens 42, which corrects the chromatic aberration of magnification.

In the green, yellow, and blue light components reflected by the dichroic mirror 21, the green and yellow light components are reflected by the dichroic mirror 22 and sent via the condenser lens 26 to a Ye modulation element 30Y, which modulates the yellow light components. In the yellow light components modulated by the Ye modulation element 30Y, only optical components aligned with a transmission axis of an entrance polarizer 32g in the green liquid crystal light valve 30G enter the green liquid crystal light valve 30G. The green liquid crystal light valve 30G modulates the green light components. In this manner, the modulated green light components are superimposed with the modulated yellow light components and sent to the cross dichroic prism 41.

The blue light components reflected by the first dichroic mirror 21 are transmitted through the second dichroic mirror 22. The blue light components then travel to the full reflection mirror 23b, the relay lens 24b, the full reflection mirror 23c, and the condenser lens 27, and enter the blue liquid crystal light valve 30B. The blue light components that enter the blue liquid crystal light valve 30B are modulated and sent to the cross dichroic prism 41.

The cross dichroic prism 41 combines the red light components, the green light components superimposed with the yellow light components, and the blue light components. The combined light is then projected from the projection lens 50 toward a screen or like.

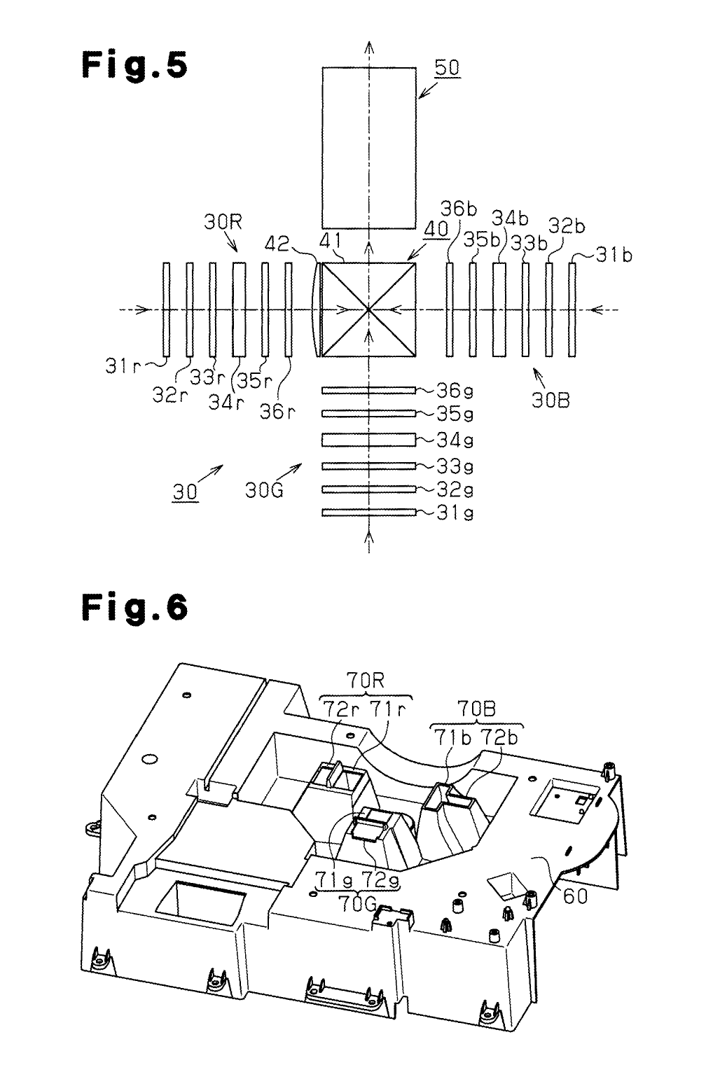

As shown in FIG. 5, the red liquid crystal light valve 30R includes an entrance pre-polarizer 31r (inorganic polarizer), an entrance polarizer 32r, an optical compensator 33r, an LCD panel 34r including liquid crystal cells and the like, an exit pre-polarizer 35r, and an exit polarizer 36r. The entrance pre-polarizer 31r polarizes the elliptically polarized red light from the condenser lens 25 into red light that is linearly polarized in a fixed direction. The entrance polarizer 32r transmits only the light linearly polarized in the fixed direction. Further, the entrance polarizer 32r cooperates with the exit polarizer 36r to transmit polarized light in a fixed direction that is modulated by the LCD panel 34r. The optical compensator 33r compensates for birefringence in the LCD panel 34r. The LCD panel 34r modulates the entering red light based on an image signal. The exit pre-polarizer 35r decreases the amount of light to reduce the load on the exit polarizer 36r.

The green liquid crystal light valve 30G and the blue liquid crystal light valve 30B basically have the same structure as the red liquid crystal light valve 30R although the color of the modulated light is different. Thus, the green and blue liquid crystal light valves 30G and 30B include entrance pre-polarizers 31g and 31b, entrance polarizers 32g and 32b, optical compensators 33g and 33b, LCD panels 34g and 34b, exit pre-polarizer 35g and 35b, and a exit polarizers 36g and 36b that correspond to the entrance pre-polarizer 31r, the entrance polarizer 32r, the optical compensator 33r, the LCD panel 34r, the exit pre-polarizer 35r, and the exit polarizer 36r, respectively.

The LCD projector, which includes the optical systems described above, is provided with a cooling system that cools optical components by sending cooling air to gaps between the optical components. FIG. 6 is a schematic diagram showing the cooling system in one embodiment. In the present specification, the frame of reference for the upward and downward directions is the state shown in FIG. 6. Further, the upward and downward directions correspond to the upward and downward directions of the LCD projector when set in an upright state.

As shown in FIG. 6, the cooling system includes a duct 60, which is arranged under the optical system that includes the liquid crystal light valves 30R, 30G, and 30B. The duct 60 is in communication with a plurality of nozzles 70. Cooling air is produced by cooling fans and sent through the duct 60 to each nozzle 70. Cooling air is blown from the nozzles 70 toward the optical components of the liquid crystal light valves 30R, 30G, and 30B. The nozzles 70 are arranged on an upper surface of the duct 60. The nozzles 70 include a nozzle 70R, which blows out cooling air toward the red liquid crystal light valve 30R, a nozzle 70G, which blows out cooling air toward the green liquid crystal light valve 30G, and a nozzle 70B, which blows out cooling air toward the blue liquid crystal light valve 30B. Although not shown in the drawings, the cooling fans, which send cooling air to the nozzles 70R, 70G, and 70B, are arranged in the duct 60 shown in FIG. 6.

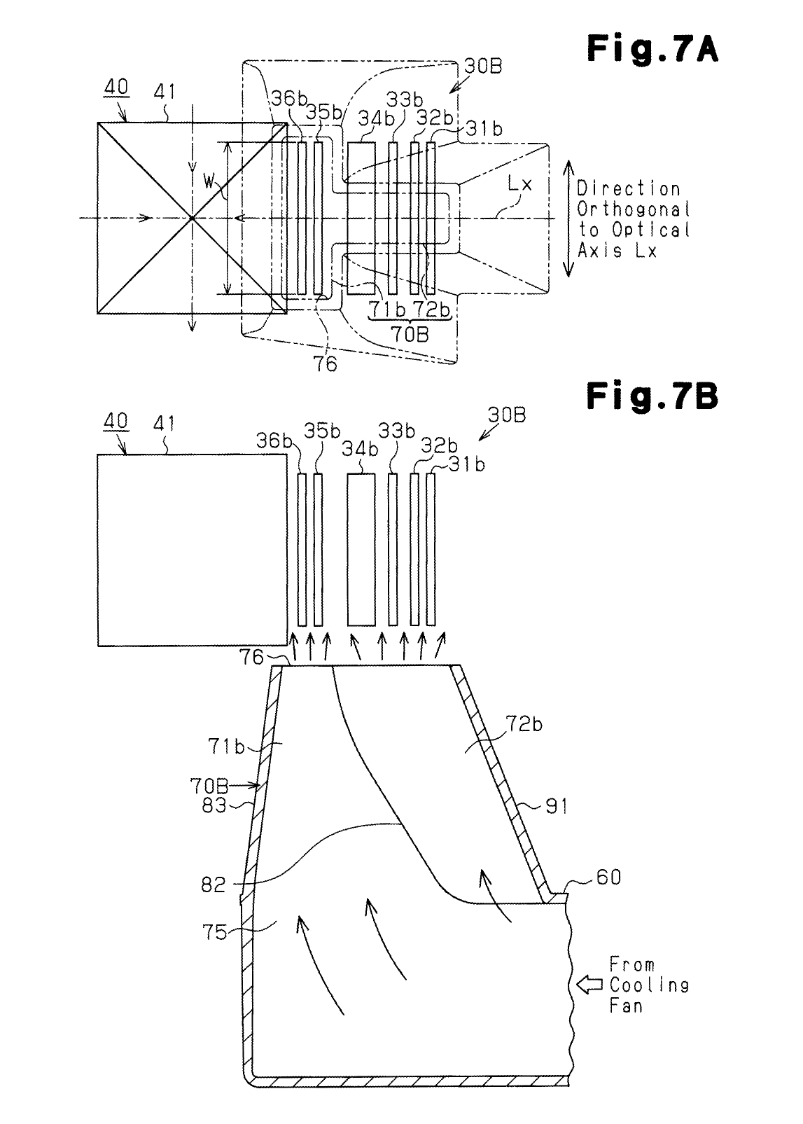

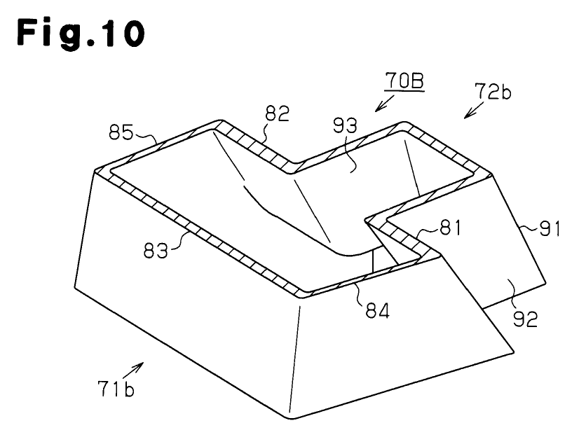

In the present embodiment, a nozzle implementing the main features of the present invention is applied to the nozzle 70B that blows out cooling air toward the blue liquid crystal light valve 30B, that is, the cooling system that cools the optical components of the blue liquid crystal light valve 30B. In the present embodiment, the cooling system that cools the red and green liquid crystal light valves 30R and 30G is similar to that of the cooling system in the prior art. The nozzles that blow cooling air toward the optical components of the liquid crystal light valves 30R and 30G are similar to those used in the prior art. Thus, the cooling system that cools the optical components of the blue liquid crystal light valve 30B, in particular, the nozzle 70B will now be described with reference to FIGS. 7 to 10.

As shown in FIG. 7B, the nozzle 70B forms a single current passage, which includes an inlet 75, which is in communication with the duct 60, and an outlet 76, which blows out the cooling air from the inlet 75. As shown in FIG. 7A, the outlet 76 of the nozzle 70B includes a width in a direction orthogonal to the optical axis Lx of the light entering the blue liquid crystal light valve 30B. The width of the outlet 76 does not have to be fixed and may be set so that a blowing range is set for each optical component of the blue liquid crystal light valve 30B. This is the basic concept of the cooling system according to the present invention.

In the present embodiment, the nozzle 70B includes a first blowing portion arranged in correspondence with optical components that do not require to be cooled by a large amount of cooling air. The first blowing portion includes an outlet having a first width of which center is the optical axis Lx. The first width is set to a relatively small value. The nozzle 70B also includes a second blowing portion arranged in correspondence with optical components that require to be cooled by a large amount of cooling air. The second blowing portion includes an outlet having a second width, which is set to a relatively large value. In the present embodiment, the outlet 76 of the nozzle 70B is formed by the outlet of the first blowing portion and the outlet of the second blowing portion. Further, the second width is greater than the first width. Accordingly, in the cooling system that uses the nozzle 70B, cooling air is blown at a relatively high velocity from the first blowing portion toward the central part of optical components that do not require the blowing of a large amount of cooling air. This efficiently cools such optical components while reducing the amount of cooling air. The reduction in the cooling air allows more cooling air to be used for the optical components that require to be cooled by a large amount of cooling air.

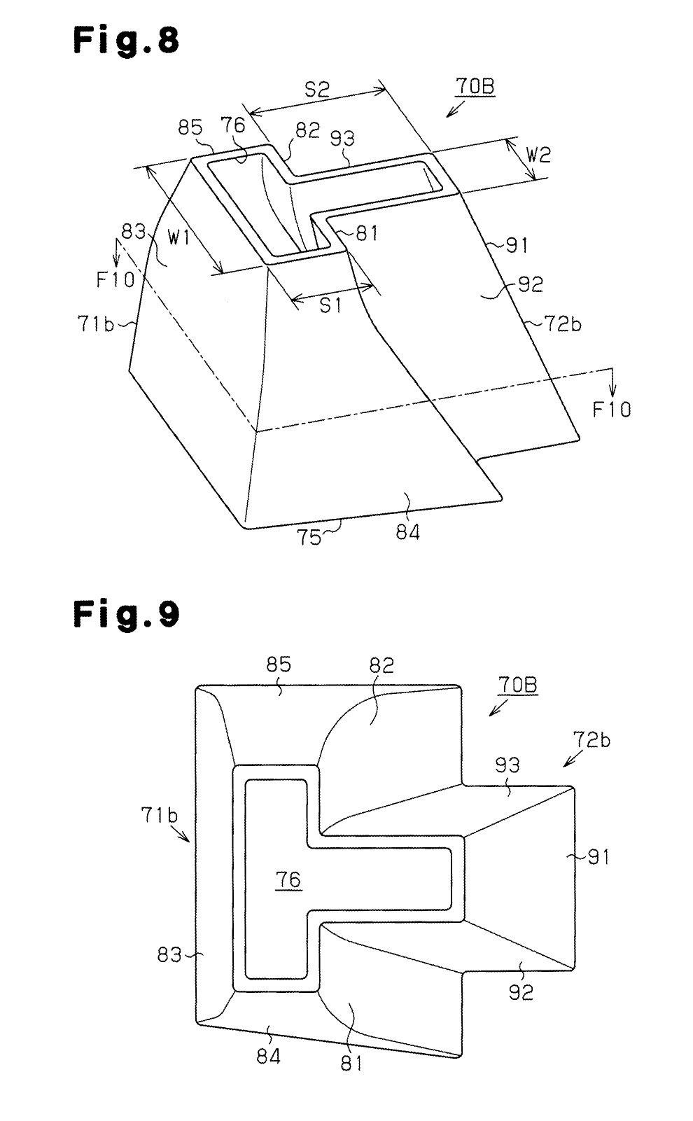

In the present example, optical components located at the exit side of the LCD panel 34b in the blue liquid crystal light valve 30B have relatively low heat resistance in the same manner as the prior art. Thus, such optical components require a large amount of cooling air. In contrast, optical components located at the entrance side of the LCD panel 34b in the blue liquid crystal light valve 30B have relatively high heat resistance as compared to the prior art. Thus, such optical components do not require a large amount of cooling air. Accordingly, even if the light source lamp has a high illuminance, the nozzle 70B allows for the use of an organic polarizer that has a superior polarizing capability as the exit polarizer. An organic polarizer is superior to an inorganic polarizer in polarizing capability but inferior in heat resistance and light resistance. The setting of the width at the outlet 76 of the nozzle 70B will now be described. The center of the width lies along the optical axis Lx. As shown in FIGS. 7A and 8, the nozzle 70B includes an exit side portion 71b and an entrance side portion 72b. The exit side portion 71b blows cooling air toward the exit side optical components (in FIG. 7A, the exit pre-polarizer 35b and the exit polarizers 36b). The entrance side portion 72b blows cooling air toward the entrance side optical components (in FIG. 7A, the entrance pre-polarizer 31b, the entrance polarizer 32b, and the optical compensator 33b). The optical components have a width W, and the exit side portion 71b has a width W1, which is the same or slightly greater than the width W. The entrance side portion 72b has a width W2, which is less than the width W of the optical components. The entrance side portion 72b is one example of the first blowing portion of the nozzle 70B, and the width W2 is one example of the first width. Further, the exit side portion 71b is one example of the second blowing portion of the nozzle 70B, and the width W1 is one example of the second width.

In this manner, the nozzle 70B is T-shaped as viewed from above and has widths that change at a boundary formed at a portion corresponding to the LCD panel 34b. Here, the exit side portion 71b has an optical axis direction dimension S1, which is set in correspondence with an optical axis direction dimension of the region in which the exit side optical components are arranged. Further, the entrance side portion 72b has an optical axis direction dimension S2, which is set in correspondence with an optical axis direction dimension of the region in which the entrance side optical components are arranged (see FIGS. 7 and 8).

As shown in FIGS. 8 to 10, the nozzle 70B include walls 81, 82, 83, 84, 85, 91, 92, and 93 that form the exit side portion 71b and the entrance side portion 72b. The walls 81, 82, 83, 84, 85, 91, 92, and 93 are arranged so that the nozzle 70B widens from the outlet 76 toward the inlet 75. Among the walls 81 to 85 that form the exit side portion 71b, the walls 81 and 82 extend in a direction orthogonal to the optical axis Lx and are located at the upstream side of the duct 60. Further, the walls 81 and 82 are smoothly curved to widen toward the upstream side of the duct 60.

The operation of the cooling system that cools the optical components of the blue liquid crystal light valve 30B will now be described.

Cooling air flows through the duct 60 from the cooling fan to the nozzle 70B and enters the entrance side portion 72b and the exit side portion 71b. The amount of cooling air that flows out of the exit side portion 71b and the entrance side portion 72b is determined by the shapes of the exit side portion 71b and the entrance side portion 72b, more specifically, the shape and area of the outlet 76, the shape and area of the inlet 75, and the inclination and shapes of the walls 81 to 85 and 91 to 93.

In this embodiment, the walls 81, 82, 83, 84, 85, 91, 92, and 93 that form the exit side portion 71b and the entrance side portion 72b widen from the outlet 76 toward the inlet 75. Thus, the circulation resistance is small from the duct 60 to the nozzle 70B. This allows for reduction in the power of the cooling fan and increases the amount of discharged air. In particular, the walls 81 and 82 of the exit side portion 71b, which extend orthogonal to the optical axis Lx and are located at the upstream side, are smoothly curved and greatly inclined. Thus, cooling air is smoothly guided from the duct 60 to the exit side portion 71b, which requires a large amount of air.

Further, the width W1 of the exit side portion 71b and the width W2 of the entrance side portion 72b are set to adjust the blowing amount and blowing range of the cooling air from the exit side portion 71b and the entrance side portion 72b. In particular, the width W1 of the exit side portion 71b is set to be the same or slightly greater than the width W of the optical components. Thus, for the exit side optical components having a small heat resistance, cooling air is blown against the optical components entirely in the widthwise direction. In contrast, the width W2 of the entrance side portion 72b is set to be less than the width W of the optical components. Thus, for the entrance side optical components having a large heat resistance, cooling air is blown against central parts of the optical components with respect to the widthwise direction at a relatively high velocity. As a result, the cooling air blown against the central parts of the optical components at a relatively high velocity efficiently cools the optical components with a relatively small amount of air. Further, the reduced amount of cooling air blown against the entrance side optical components increases the amount of cooling air used to cool the exit side optical components.

The above cooling system, namely, the structure of the nozzle 70B, may also be used in the same manner in a cooling system that cools the optical components of the red liquid crystal light valve 30R or the green liquid crystal light valve 30G. However, in the present embodiment, the nozzle implementing the main features of the present invention is not applied to the systems that cool the red liquid crystal light valve 30R and the green liquid crystal light valve 30G. This is because the amount of emitted light is small and the generated amount of heat is low in the red liquid crystal light valve 30R. Thus, the need for using cooling air on the optical components of the red liquid crystal light valve 30R is small with regard to heat resistance. On the other hand, a large amount of light is emitted for the green liquid crystal light valve 300, and there is no margin allowing for reduction in the amount of cooling air that cools the entrance side optical components.

The cooling system of the present embodiment has the advantages described below.

(1) The nozzle 70B blows out cooling air from a single current passage, namely, the outlet 76, entirely to the optical components of the blue liquid crystal light valve 30B. Accordingly, that is no partition that partitions the cooling air outlet into two like in the prior art. Thus, the entire space used for the nozzle 70B is effectively used as a single outlet. Further, there is no gap like that in the prior art between the entrance side portion 72b and the exit side portion 71b. Thus, there are no parts in the optical components of the liquid crystal light valve 30B that do not receive cooling air. This entirely cools the optical components.

(2) There is no deflector like that of the prior art projecting into the duct from the inlet. Since there is no deflector, pressure loss does not occur and noise is not produced. Further, cooling air is efficiently blown.

(3) The outlet 76 of the nozzle 70B has a width that is set so that the range in which the cooling air is blown is basically selected for each optical component of the cooling subject. More specifically, the width is small for the outlet of the blowing portion for the optical components that do not require a large amount of cooling air to be blown. In contrast, the width is large for the outlet of the blowing portion for the optical components that requires a large amount of cooling air to be blown. In this manner, the amount of air and the blowing range are set for each optical component. This allows for efficient cooling with the cooling air.

(4) For an optical component having a high heat resistance, cooling air is blown at a high velocity against the central part of the optical component where the temperature easily rises. Thus, the cooling air efficiently cools the optical components with a relatively small amount of cooling air. This allows for an increase in the amount of cooling air provided to optical components having low heat resistance. Further, the cooling air is blown entirely against optical components having a low heat resistance. This prevents the temperature from rising entirely in such optical components.

(5) In the cooling system that cools optical components of the blue liquid crystal light valve 30B, cooling air is blown against the central part of each entrance side optical component having high heat resistance in the widthwise direction. This efficiently cools such optical components with a small amount of cooling air.

(6) In the cooling system that cools optical components of the blue liquid crystal light valve 30B, cooling air that does not have to be used to cool the entrance side optical component is added to the cooling air that cools the exit side optical components. This allows the exit side optical components to have a low heat resistance. Thus, an organic polarizer having a superior polarizing capacity can be used as the exit polarizer to obtain an image with high quality.

(7) The nozzle 70B includes the walls 81, 82, 83, 84, 85, 91, 92, and 93 that form the exit side portion 71b and the entrance side portion 72b. Further, the walls 81, 82, 83, 84, 85, 91, 92, and 93 widen from the outlet 76 toward the inlet 75. Thus, the circulation resistance is reduced from the duct 60 to the nozzle 70B, and the amount of cooling air can be increased.

(8) In the nozzle 70B, the walls 81 and 82, which extend in a direction orthogonal to the optical axis Lx and are located at the upstream side, are smoothly curved to widen toward the upstream side of the duct 60. This smoothly guides cooling air from the duct 60 to the nozzle 70B. Thus, the circulation resistance is reduced from the duct 60 to the nozzle 70B, and the amount of cooling air can be increased.

(9) In the three-chip LCD projector, a nozzle implementing the main features of the present invention is applied to the cooling system that cools the optical components of the blue liquid crystal light valve 30B. This effectively obtains the advantages of the present invention.

It should be apparent to those skilled in the art that the present invention may be embodied in many other specific forms without departing from the spirit or scope of the invention. Particularly, it should be understood that the present invention may be embodied in the following forms.

In the present invention, when the optical components of a liquid crystal light valve serving as a cooling subject does not have the same heat resistance, the width W1 of the outlet 76 (blowing portion) is changed in the direction orthogonal to the optical axis Lx in correspondence with the heat resistance of the optical components. For example, in the above embodiment, there is a difference between the heat resistance of the entrance side optical components and the heat resistance of the exit side optical components. Further, the entrance side optical components have a high heat resistance. Accordingly, the outlet 76 is T-shaped as viewed from above. However, the outlet 76 does not have to be T-shaped as viewed from above. In other words, any structure that reduces the width at the portion at which cooling air is blown toward optical components having a high heat resistance is included in the present invention. Accordingly, the shape of the outlet 76 as viewed from above is not limited to a specific shape such as a T-shape and may have a different shape such as a cross-shape or an H-shape.

In the above embodiment, the outlet 76 (blowing portion) is set to have two widths, width W1 and width W2. However, the outlet 76 may have three or more widths in correspondence with the heat resistance level of the optical components. In this case, the second optical component having a low heat resistance of the present invention may be an optical component having the lowest heat resistance, and the first optical component having a high heat resistance may be an optical component having a higher heat resistance than the optical component having the lowest heat resistance.

The relative positional relationship of the flow of cooling air in the duct 60 and the nozzle 70B in the above embodiment is such that the entrance side portion 72b of the nozzle 70B is located at the upstream side of the duct 60, and the exit side portion 71b of the nozzle 70B is located at the downstream side of the duct 60. However, in the present embodiment, the relative positional relationship of the flow of cooling air in the duct 60 and the nozzle 70B is not limited in any manner. That is, the arrangement of the entrance side portion 72b (first blowing portion) and exit side portion 71b (second blowing portion) of the nozzle 70B is not limited and may be, for example, reversed or rotated by 90 degrees.

In the above embodiment, a nozzle implementing the main features of the present invention is applied to the cooling system that cools the optical components of the blue liquid crystal light valve 30B but may also be applied to the cooling system that cools the red liquid crystal light valve 30R or the green liquid crystal light valve 30G. A nozzle implementing the main features of the present invention may be applied to cool at least one of the three liquid crystal light valves 30R, 30G, and 30B. In other words, the nozzle may be applied to any one or two of the three liquid crystal light valves 30R, 30G, and 30B or all three of the liquid crystal light valves 30R, 30G, and 30B.

When a nozzle implementing the main features of the present invention is applied to the green liquid crystal light valve 30G, it is preferable that the cooling system also cool the Ye modulation element 30Y. The LCD projector to which the present invention is applied may be one that does not include the Ye modulation element 30Y in the optical system for the green liquid crystal light valve 30G.

In the present embodiment, in the system for the red liquid crystal light valve 30R, the aberration correction lens 42 is arranged on the entrance surface of the cross dichroic prism 41. However, the LCD projector to which the present invention is applied may be one that does not include the aberration correction lens 42. In addition, the LCD projector to which the present invention is applied may be one that includes the aberration correction lens 42 in the system for each color.

In the LCD projector of the above embodiment, although not particularly mentioned above, a dedicated cooling fan is used for each of the red liquid crystal light valve 30R, the green liquid crystal light valve 30G, and the blue liquid crystal light valve 30B. However, the liquid crystal light valves do not have to use dedicated cooling fans, and liquid crystal light valves may be combined to share a cooling fan.

The red liquid crystal light valve 30R, the green liquid crystal light valve 30G, and the blue liquid crystal light valve 30B are only required to respectively include the LCD panels 34r, 34g, and 34b, the entrance polarizers 32r, 32g, and 32b, and the exit polarizers 36r, 36g, and 36b. The other optical components may be added or eliminated in accordance with the structure of each liquid crystal light valve. An entrance polarizer is one example of the first optical component having a high heat resistance, and the exit polarizer is one example of the second optical component having a low heat resistance.

Specific dimensions of the exit side portion 71b and the entrance side portion 72b are affected by the heat resistance of the optical components, the capacity of the cooling fan, and the like. Thus, dimensions that were not described above are illustrated in the drawings as examples and do not limit the present invention.

In the above embodiment, the nozzles 70B, 70G, and 70R are formed integrally with the duct 60. However, the nozzles 70B, 70G, and 70R may be formed discretely from the duct 60 and be adhered and fixed to the upper surface of the duct. 60.

The LCD projector according to the present invention may be used in an image display system for various types of facilities such as a home theater, a conference room, a training room, a class room, a recreation room, an exhibition room, and a studio.

The present examples and embodiments are to be considered as illustrative and not restrictive, and the invention is not to be limited to the details given herein, but may be modified within the scope and equivalence of the appended claims.

1. An LCD projector comprising:
a plurality of liquid crystal light valves that modulate light, wherein each of the liquid crystal light valves includes a plurality of optical components;
a duct through which cooling air flows to cool the optical components of each of the liquid crystal light valves; and
a plurality of nozzles respectively arranged in correspondence with the liquid crystal light valves, wherein each of the nozzles blows the cooling air from the duct toward the optical components of the corresponding liquid crystal light valve, wherein
at least one of the nozzles is formed by a single current passage that includes an inlet, which is in communication with the duct, and an outlet, which blows out the cooling air from the inlet,
the outlet has a width in a direction orthogonal to an optical axis of light that enters the corresponding liquid crystal light valve, and
the width is set so that a blowing range of the cooling air is selected for each of the optical components in the corresponding liquid crystal light valve.

2. The LCD projector according to claim 1, wherein:
the outlet is arranged so that a center of the width lies along the optical axis;
the optical components of each of the liquid crystal light valves includes a first optical component having a high heat resistance and a second optical component having a low heat resistance; and
the at least one of the nozzles includes:
a first blowing portion that blows out cooling air toward the first optical component, wherein ₜhe first blowing portion has a first width that is less than a width of the first optical component in the direction orthogonal to the optical axis; and
a second blowing portion that blows out cooling air toward the second optical component, wherein the second blowing portion has a second width that corresponds to a width of the second optical component in the direction orthogonal to the optical axis,
wherein the width of the outlet is set so that the outlet has the first width and the second width.

3. The LCD projector according to claim 2, wherein:
at least one of the liquid crystal light valves includes an LCD panel, the first optical component arranged at an entrance side of the LCD panel, and the second optical component arranged at an exit side of the LCD panel;
the first optical component has a higher heat resistance than the second optical component; and
the outlet is T-shaped when viewed from above and has the first width and the second width.

4. The LCD projector according to claim 2, wherein the at least one of the nozzles includes a wall that forms the first and second blowing portions, and the wall is formed to widen from the outlet to the inlet.

5. The LCD projector according to claim 4, wherein the wall includes an upstream wall that forms the second blowing portion and extends in the direction orthogonal to the optical axis, and the upstream wall is smoothly curved to widen in an upstream direction.

6. The LCD projector according to claim 1, wherein
the plurality of liquid crystal light valves includes a red liquid crystal light valve, a green liquid crystal light valve, and a blue liquid crystal light valve; and
the nozzle corresponding to the blue liquid crystal light valve is set so that a blowing range of the cooling air is selected for each of the optical components in the blue liquid crystal light valve.

7. An LCD projector comprising:
a plurality of liquid crystal light valves that modulate light, wherein each of the liquid crystal light valves includes a plurality of optical components;
a duct through which cooling air flows to cool the optical components of each of the liquid crystal light valves; and
a plurality of nozzles respectively arranged in correspondence with the liquid crystal light valves, wherein each of the nozzles blows the cooling air from the duct toward the optical components of the corresponding liquid crystal light valve, wherein
at least one of the nozzles includes a single outlet that blows out the cooling air,
the outlet is formed to blow the cooling air at a first velocity toward at least one of the optical components of the corresponding liquid crystal light valve and blow the cooling air at a second velocity toward at least another one of the optical components of the corresponding liquid crystal light valve.
